(19) United States
(12) Patent Application Publication
(10) Pub. No.: US 2025/0276407 A1
(43) Pub. Date: Sep. 4, 2025

(54) WELDING GROUP AND KIT FOR WINDING MACHINES

(71) Applicant: BF S.R.L., Castelgomberto (VI) (IT)

(72) Inventor: Massimo FABRIS, Castelgomberto (VI) (IT)

(73) Assignee: BF S.R.L., Castelgomberto (VI) (IT)

(21) Appl. No.: 18/863,786

(22) PCT Filed: May 21, 2023
(86) PCT No.: PCT/IB2023/055213

§ 371 Date: Nov. 7, 2024

(30) Foreign Application Priority Data
May 20, 2022 (IT) 202022000002060
May 19, 2023 (IT) 102023000010269

(51) Int. Cl. B23K 26/08; B23K 26/26; B23K 37/02; B23K 101/16; B23K 101/36

(52) U.S. Cl. CPC B23K 26/0869; B23K 26/083; B23K 26/26; B23K 37/0235; B23K 2101/16; B23K 2101/36

(57) ABSTRACT

A welding group for winding machines of the type used in the production of windings intended for medium and high voltage electric transformers to be used in the generation, transmission and distribution of electric power. The welding group includes at least one laser welding head and a handling system (20) for the welding head. The welding head includes: a carriage, in the form of a frame having a lower part, an upper part, and at least one right side part or at least one left side part; first retaining means for slidingly constraining the carriage to the structure of the winding machine, the means being placed on the upper part of the carriage; and a first actuator which, in association with the first retaining means, slidingly moves the carriage on at least one axis.

### CROSS-REFERENCE TO RELATED APPLICATIONS

This application is a § 371 U.S. National Phase of International Patent Application PCT/IB2023/055213, filed May 21, 2023, which claims priority of Italian Patent Applications Numbers 202022000002060 and 102023000010269, filed May 20, 2022 and May 19, 2023, respectively, the entire contents of all of which are incorporated by reference herein as if fully set forth.

### TECHNICAL FIELD

The present invention relates to welding technology for winding machines, preferably of the type used in the production of windings intended for medium and high voltage electric transformers to be used in the generation, transmission and distribution of electric power.

### BACKGROUND

The invention relates to a winding machine of the type shown in the enclosed FIG. 1. Such a known winding machine substantially consist of: a decoiler unit (A), which allows the conductive material to be unwound from suitable reels or coils (the decoiler unit can be disengaged from the frame of the machine); a central unit (B), for preparing/positioning the conductive and insulating materials in view of the winding step (e.g. cutting of the insulating material); and a winding unit (C), which allows the conductive and insulating materials to be wound around a winding core.

In particular, the winding unit (C) includes two assemblies consisting of a tailstock (11) and a winding device (11′) which rotatably constrain therebetween the ends (121,121′) of a winding reel (12) in a parallel direction with respect to the ground (i.e. along the X axis).

The tailstock (11) includes an opening/closing system, typically a hinged closure, which enables, before and after the winding operation, to introduce the winding core and to extract the winding coil respectively. The winding device (11′) includes a motor (15) to rotate the winding reel (12) generally at high speeds.

In this kind of winding machines, the coils feature several turns of copper wires (or other conductive material in the form of wire, foil or plate), which are wound around the winding core alternated between layers of insulation material e.g. paper strips.

Although not exclusively, the present invention is specifically aimed at winding machines of the type described used in the production of windings (or coils) in metal foils or plates typically intended for medium and high voltage transformers to be used for the generation, transmission and distribution of electric power.

For example, in such transformers the input electrode (jargon named “inlet bar”) is connected to a high-voltage (>50.000 V) supply while a medium voltage (e.g. 380 V) is delivered through the output electrode (jargon named “outlet bar”).

Inlet/outlet bars are made of copper or aluminum. They present a shape, length and thickness depending on the characteristics of the transformer for which they are intended. They typically range in length from 200 to 1500 mm and have a thickness of about 20 mm. The foil that forms the winding is made of copper or aluminum, and typically has a length ranging between 200 and 1500 mm and a thickness of 2 mm. To form the winding the conductive foil is wound on insulating paper (or other dielectric materials) between layers around a core. The winding is limited by an inner end, where the coil starts, and an outer end where the coil ends.

In manufacturing such transformers, it is necessary to weld the inlet and outlet bars, respectively, at the inner and outer ends of the winding. Depending on the power rating of the transformer, and thus the size range of the bars and foil, welding operations are carried out by two different techniques.

The first technique, known in the field as “head welding”, the coil plate (about 2 mm thick) and the head of the inlet/outlet bar (e.g., 20 mm thick) are brought together and mechanical pressure is applied along the axial direction. In this way, a side weld seam is made along the entire length of the bar (e.g., 1500 mm). To facilitate the operation, the plate is pressed against the head of the bar by a set of pressers, the number of which depends on the length of the machine. In this technique, the welding group is placed in front of the winding unit (C).

In the electric transformers industry another welding technique is known under the term “butt welding”. In this case, before welding, the winding plate is pressed against the inlet/outlet bar by two rows of side pressers, the number of which depends on the length of the machine. The weld seam is thus made on the top surface of the foil along the entire length of the bar. In this technique, the welding group is placed behind the winding unit (C).

Normally, winding machines are configured to perform welding operations by only one of the techniques described. In fact, machines capable of performing both “head welding” and “butt welding” are too expensive compared to the benefits they achieve. Generally, “head welding” is preferable when the bar and/or plate are thick and the “butt technique” is not efficient.

In both techniques, it is essential that the welding operation provides not only a mechanically-strong joint but, above all, a highly uniform weld seam. In fact, non-uniform weld seams present uneven resistivity and portions of the joint under stress due to an excess of current flow.

In turn, this can result in performance deviation from specifications and even premature transformer failure due to the occurrence of short circuits.

Currently, to obtain a good joint the welding operation is done by means of a TIG torch in a helium or argon atmosphere to prevent oxidation and achieve proper melting of the weld pool.

TIG welding has several drawbacks mostly related to the low energy efficiency of this technology, which in turn results in low productivity of the winding machine.

In fact, by means of a typical 500 A TIG torch about 20 minutes are required to weld a 2 mm copper (or aluminum) plate to a 20 mm thick, 1500 mm long copper (or aluminum) outlet bar.

In addition, the high temperature generated by the welding operation results in heat dissipation problems that slow or stop subsequent machining operation. For this reason, to handle windings operators are often forced to use uncomfortable personal protective equipment or forced air cooling systems, which further degrade energy performance. Finally, the high heat generated by the TIG flashlight can result in damage to the cylinders of the pressing system.

Last but not least, in the last years cost of helium as increased to an unsustainable level, which forced many welding equipment manufacturers to turn to argon. Unfortunately, this alternative is also expensive and is not a solution.

Although these limitations are well-known, no significant improvements are currently known to the present inventor, who has over 30 years of experience in the field.

A state-of-the-art search highlighted alternative welding technologies. For example, several patent publications describe the use of laser welding systems in the manufacturing process of transformer windings.

However, such applications of laser technology refer either to welding robots intended for complex production lines (e.g., CN213702197U “Eight-axis laser winding welding machine”), or to machines having an entirely different structure from the object of the present invention (FIG. 1) since they are intended for low-voltage (<100V) small windings manufacturing. Examples of such machines are described in CN215955072U “Welding mechanism of surface-mounted inductive coil winding machine” or in CN214505256U “Intelligent large annular iron core winding machine”. It is worth noting that in such applications (e.g., the aforementioned utility model CN213702197U) the coil is made of wire and not of metal foils or plates.

In summary, the patent literature does not provide any useful teachings to those skilled in the art wishing to apply a laser welding head to a winding machine of the type shown in FIG. 1 for manufacturing electrical windings intended for medium to high voltages, and therefore having a significant size. In particular, there are no known applications of laser welding technology to welding operations required in the fabrication of metal foils, plates or bandings windings intended for distribution transformers.

Therefore, at present, improvements can still be made to the welding assembly of winding machines intended for the production of medium and high-voltage transformer windings for power generation, transmission and distribution.

In view of the above, the present invention intends to overcome the existing disadvantages and drawbacks of the prior art by providing a winding machine of the type shown in the enclosed FIG. 1, which includes an improved welding group. Said group enables greater weld seam uniformity between the inlet/outlet bars and the ends of the coil which can be made from metal foil, plate or banding wrapped around a core.

A second important object of the present invention is to provide an improved welding group in the form of a welding kit that can be applied to retrofit winding machines equipped with a conventional TIG welding group or even not provided of any welding group.

A third important object of the present invention is to provide a winding machine comprising an improved welding group or equipped with a retrofitting welding kit capable of performing both “head welding” and “butt welding” operations on conductors in the form of metal foil, plate or banding, depending on the specifications of the winding to be manufactured.

A fourth important object of the present invention is to provide a winding machine including an improved welding group that can ensure greater safety for operators, particularly by reducing potential exposure to high-temperature sources.

Finally, a further object of the present invention is to provide said winding machine and said retrofitting welding kit by means of known and cost-effective technologies.

### SUMMARY

These and still other purposes, which will appear more clearly in the detailed description which follows, are achieved by a welding group for a winding machine, a winding machine including said group and a retrofitting kit including said welding group.

General features of said welding group, winding machine and retrofitting kit are set forth in the appended claims. The aforesaid claims, to which reference should be made for the sake of brevity, are hereinafter specifically defined and are intended as an integral part of the present specification.

In summary, the welding group according to the invention is characterized in that it includes a laser source integral to a carriage which is slidingly constrained to the structure of a winding machine by suitable means, e.g., linear guides combined with sliding shoes.

In this way, once the winding machine is equipped with the welding group (even by retrofitting a winding machine not provided of any welding group or having a conventional TIG welding group), the carriage, and hence the laser source, can be displaced from a rest position to a working position along the horizontal (X) axis by means of a suitable first actuator.

In turn, to provide an additional degree of freedom to the group, the laser source can also be slidingly constrained to the carriage by an appropriate second actuator. Movements of the welding group along other axes are also possible.

In an alternative embodiment, the carriage is not present and it is replaced by a translation device.

In further embodiments, the welding group is used as a retrofitting kit to retrofit a plurality of winding machines, not provided of any welding group, so that the welding group is shared by each machine and is part of it only when the winding machine is required to perform the welding operation.

In this way, the carriage, or the translation device, and hence the laser source, can be displaced along the horizontal axis (X) by means of a suitable actuator from a rest position to a working position corresponding to the position of the winding machine of the plurality that is required to perform the welding operation.

Clearly, this embodiment is particularly advantageous because the cost of the welding group is shared among the different winding machines. Other advantages shall appear by the detailed illustration of some embodiments which follows.

The welding group according to the invention is suitable for application on winding machines suitable for producing windings for medium or high-voltage transformers. Preferably, the conducting material of the winding is in the form of a metal foil, plate or banding. However, the invention can also be used in the production of windings with conducting material in the form of a wounded wire.

In order to achieve the optimal welding conditions, the welding group according to the invention preferably includes clamping means and pressing cylinders for blocking and pressing the transformer component to be welded e.g. the transformer inlet bar or outlet bar, to the metal plate or foil.

Finally, the welding group includes protecting means such as casings or panels integral to the carriage which are configured and arranged to prevent the radiation emitted by the laser head from causing danger to an operator located near the winding machine.

Such a welding group is applicable to a single winding machine, or a plurality of machines, of the type used to manufacture windings to be used in medium and high-voltage electrical transformers for electrical power generation, transmission, and distribution.

The winding machine can be of the type having a winding reel kept parallel with respect to the horizontal X axis in a fixed position (e.g. as the one shown in FIG. 1), or having a winding reel which is positionable by means of a handling unit to an optimum position depending on the specifications of the winding to be made (in this type of machines the reel is always kept parallel with respect to the horizontal X axis but can be moved along the axis Z or the axis Y).

In this regard, useful teachings for manufacturing a winding machine with a positionable reel are provided by the pending and unpublished Italian patent application 102022000006395 “POSITIONABLE REEL WINDING MACHINE” dated 31 Mar. 2022, in the name of the present applicant, the entire disclosures of which are hereby incorporated by reference for all purposes.

### BRIEF DESCRIPTION OF THE DRAWINGS

The present invention will be more fully understood by reference to the following tables of drawings, in which:

FIG. 1 shows a winding machine of a known type, not provided of a welding group, to which the present invention is addressed;

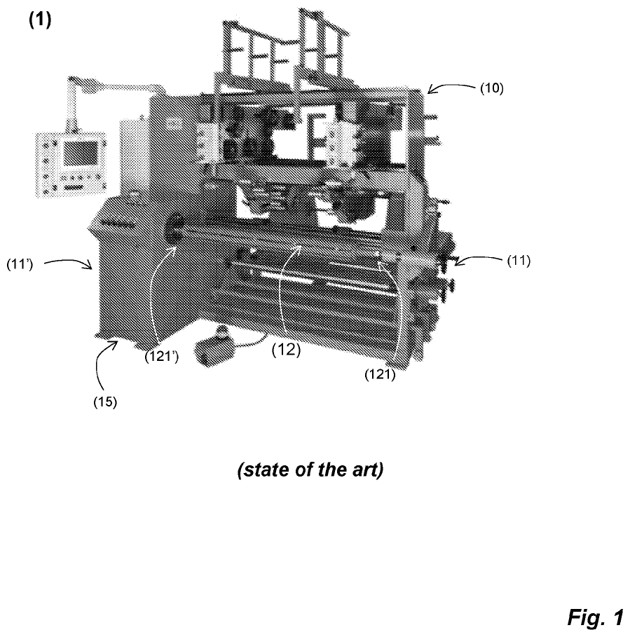

FIG. 2 is a perspective view of the welding group according to the first preferred embodiment of the present invention;

FIG. 3 is a perspective view of the winding machine equipped with the laser welding group illustrated in FIG. 2;

FIG. 4 is a perspective view of the welding group according to the second preferred embodiment of the present invention;

FIG. 5 is a perspective view of the winding machine equipped with the laser welding assembly illustrated in FIG. 4;

FIG. 6 is a perspective view of the welding group according to the third preferred embodiment of the present invention;

FIG. 7 is a perspective view of the winding machine equipped with the laser welding group illustrated in FIG. 6;

FIG. 8 schematically represents the user interface to set and adjust the parameters of the welding process with reference to the preferred embodiment of the present invention;

FIG. 9 is a perspective view of the retrofitting kit that allows a single welding group to be shared between a plurality of traditional-type winding machines;

FIG. 10 schematically illustrates a plurality of winding machines sharing a single welding group, where at letter (a) the machines are arranged according to a “series layout”, while at letter (b) the machines are arranged according to a “matrix layout”.

These figures illustrate and demonstrate various features and embodiments of the present invention but are not to be construed as limiting the invention.

### DETAILED DESCRIPTION OF THE PREFERRED EMBODIMENTS

By way of explanation of the invention, and not meant as a limitation thereof, there are provided in the following a detailed description of four preferred, but not exclusive, embodiments of the winding machine according to the invention.

For the sake of clarity, in the enclosed figures and in the description of some preferred embodiments, the welding group and the winding machine having said group mounted thereon are always indicated with reference numbers (2) and (1) respectively.

### FIRST PREFERRED EMBODIMENT

It is an object of the present invention to provide a welding group for a winding machine.

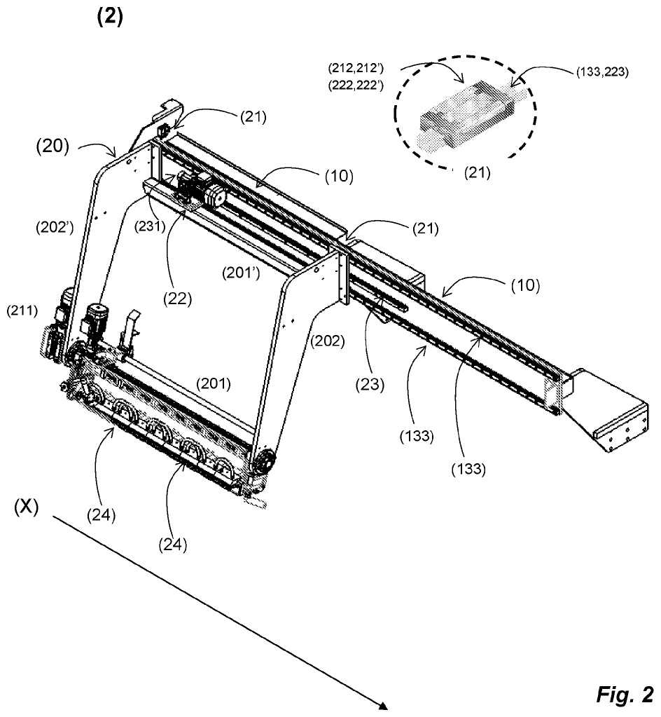

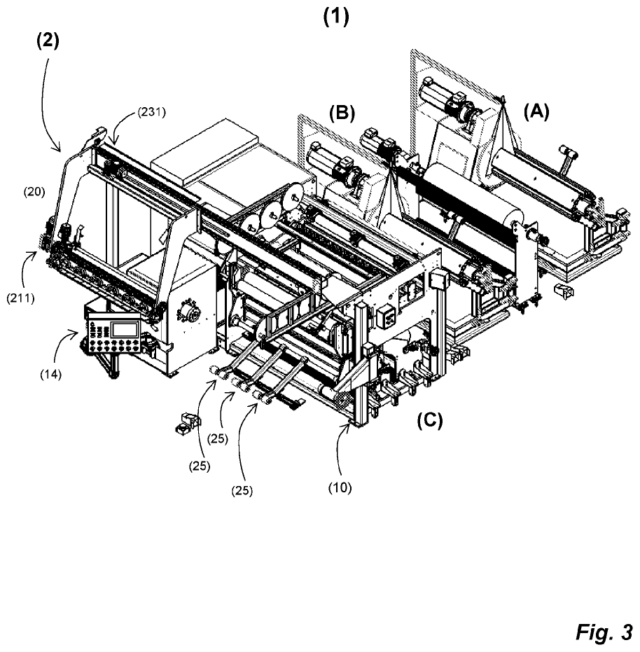

The first preferred embodiment, described herein by way of illustration and not limitation of the present invention, relates to a laser welding group, which is indicated by the reference number (2) in the enclosed FIG. 2. Said group (2) is configured to be mounted on a winding machine of the type shown in the FIG. 3 which is suitable for manufacturing windings for medium or high voltage transformers for power generation, transmission and distribution. In this type of transformer, the power range usually requires the use of a conducting material in the form of metal foils or metal plates, which are wound around a core by the winding machine.

In the first embodiment, this conducting material is in the form of a copper or aluminum foil, with a thickness of approximately 2 mm (or two overlapping 2 mm foils) and a length of 1500 mm. The metal foil is interposed with a film of dielectric material and wound around a core. The end of the conducting material which internally starts the winding, must be welded to an electrode named the ‘inlet bar’, while the other end of the winding, which externally ends the winding, must be welded to an electrode named the ‘outlet bar’. Using an appropriate number of windings, this kind of transformer can convert a voltage of e.g. 20000 V to 380 V.

In such embodiment, the welding group (2) comprises: a carriage (20) slidingly constrained to the structure of a winding machine by means of first retaining means (21) and a single laser welding head (22) integral to said carriage (20).

In the first embodiment, the welding group (2) further comprises: second retaining means (23) arranged to slidingly constrain the laser head (22) to the carriage (20) and allow movement along the axis (X); clamping means (24) for constraining the inlet/outlet bars to be welded to the metal foil.

Although highly desirable, the clamping means (24) however is not needed to implement the present invention. Neither the second retaining means (23) are required, since the laser head (22) can be constrained to a convenient fixed position of the carriage (20).

In the first embodiment, the carriage (20) is a metal frame consisting of a lower part (201), an upper part (201′) right-side part (202) and a left-side part (202′).

On the upper part (201′) of the right/left-side parts (202, 202′) of the carriage (20), two pairs of sliding shoes (212, 212′) are fixed. They are slidingly constrained to corresponding linear guides (133), directed along the axis (X), which, as will be explained below, are fixed to the structure (10) of the winding machine (1). Alternatives to sliding shoes/guides can be usefully used similarly to the first retaining means (21). For example, two pinions (212,212′), one for each side uprights, can be rotatably attached to the upper part (201′) of the two side parts (202, 202′). Pinions (212,212′) are then mechanically coupled to a rack (133) directed along the axis (X) and fixed to the structure (10) of the winding machine (1).

In any case, thanks to the first retaining means (21), and a suitable first actuator (211) fixed to the structure of the winding machine, it is possible to move the carriage (20) along the horizontal axis (X). In the first embodiment, the first actuator (211) is a translating screw jack, although other types of actuators such as a rotating screw jack, a linear motor, a hydraulic cylinder, a pneumatic cylinder, a ball screw also in combination with each other can be usefully used for this purpose.

In the first embodiment of the present invention, the welding group (2) includes second retaining means (23) which, compared to the first (21), are used to slidingly constrain the laser welding head (22) to the carriage (20). In such an embodiment, the second retaining means (23) preferably is a linear guide (222) slidingly constrained to a pair of sliding shoes (223). The linear guide (222) is directed along the horizontal axis (X) and is fixed to the lower part (201) of the carriage (20), while the pair of sliding shoes (223) is fixed to a supporting element of the laser source (22).

In turn, the supporting element is moved by means of a second actuator (231) fixed to the carriage (20) of the welding group (2). Preferably the second actuator (231) is a linear motor, although other types of actuators may conveniently be used. In this way, the laser head (22) can move along the horizontal axis (X) independently of the carriage (20).

From the description of the carriage (20) provided, it will become apparent that positions of the first and second retaining means (21,23) different than those described are possible.

In addition, equivalent alternatives to the sliding shoes/linear guide couplings, such as pinion/rack couplings, can be usefully used. By appropriately arranging the first and second retaining means (21,23), in a trivial manner for those skilled in the art, it is also possible to achieve movements of the laser welding head (22) on a greater number of axes, depending on the features of the component to be welded.

In the first embodiment of the present invention, the welding group (2) includes a plurality of clamping means (24) positioned on the lower part (201) of the carriage (20) to clamp the inlet/outlet bars to the metal foil or plate before and during the welding operation. The number of clamps and their distribution along the lower part (201) is selected according to the length of the bar (or other transformer component) to be welded. This ensures that the welding operation is performed correctly. As will be explained below, in the first embodiment, taking into account the geometry of the inlet/outlet bars, the welding operation is carried out along a straight path in both the “head welding” and “butt welding” techniques.

In addition to mechanical clamping, other means can be conveniently used such as vacuum clamping: in this case, however, using known techniques, it is necessary to create a system for generating a vacuum in the lower part (201) of the carriage (20).

In the first embodiment of the present invention, the welding group (2) includes pressing means (25) which, similarly to the clamping means (24), make simpler the welding operation, especially in the “butt welding” technique, as will be discussed below. In this embodiment the pressing means (25) are plate pressers arranged in a single row, whose number depends on the length of the machine.

Finally, in the first embodiment, described herein by way of example and not limitation of the present invention, the welding group (2) includes protecting means (26) to prevent that the laser radiation emitted by the source may have damaging effects, in particular to eyes, of the persons standing near the winding machine (1).

For example, suitable protecting means (26) can be shielding panels fixed to the carriage (20) or to the laser welding head (22).

Dimensioning and positioning of such panels, which can be carried out according to known techniques, have to ensure an adequate level of shielding and, at the same time, effective dissipation of the heat generated by the source.

As mentioned, the laser welding unit described above is arranged to be mounted on a winding machine of the type shown in FIG. 3 where it is indicated by the numerical reference (1).

Said machine (1) comprises a decoiler unit (A) of a conductor material which, in the first embodiment, is in the form of a metal foil available in coils; a central unit (B), having the task of preparing the materials unwound by the preceding unit (A), for example, cutting the insulating material into strips, or coupling the insulating material to the conductor, or correctly orienting and positioning said materials, by means of suitable devices in view of the subsequent winding operation; a winding unit (C) for winding the conducting and/or insulating materials, prepared and positioned/oriented by the central unit (B), around a suitable core integral with a winding reel (12).

In turn, the winding unit (C) comprises a frame (10), a tailstock (11) and a winding device (11′), as well as the aforementioned winding reel (12).

In the first preferred embodiment, the winding is intended for medium and high-voltage electrical transformers suitable for power generation, transmission and distribution.

Although not relevant to implement the present invention, the winding core may have an arbitrary diameter with a circular, square or more generally polygonal cross-section.

In the preferred embodiment, the welding group according to invention (2) comprises two independent actuators (211,231). This allows, first, to move the carriage (20) from the rest position to the working position, and then, to move the laser head (22) along the welding line while keeping the carriage (20) in a fixed position during the operation.

As shown in FIG. 3, in the first preferred embodiment, herein described by way of example and not as a limitation of the present invention, the welding unit (2) is positioned in front of the winding unit (C). This configuration of the machine (1) is particularly suitable for welding the inlet/outlet bars to the winding foil using the “head welding” technique. With this technique, depending on the geometry of the inlet/outlet bar, welding is performed along a straight line, parallel to the horizontal axis (X), by means of the procedure described below as an example of the present invention and not as a limitation thereof.

The carriage (20) with the laser welding head (22) is first moved from the rest position to the working position. The inlet bar is manually positioned on the lower part of the carriage (201) by an operator, or is picked up by an automatic loading system. The bar is then held with the metal foil by the clamping means (24) so that the edge of said foil is in contact with the head of the bar and is parallel to the head itself (i.e. is directed along the X axis).

At this stage, a suitable actuator positions the plate pressers (25), directed along the axis (X), so that the edge of the foil is pressed against the head of the bar and the gaps between the bar and the foil, which could slow down the welding operation or impair its quality, are avoided.

Then, the laser source (22) mounted on a supporting element is switched on and it is displaced along the linear guide (222) by means of the linear motor (231) to perform the welding operation according to the parameters set by the operator (more details will be provided in the following).

At the end of the operation, the laser source (22) is switched off, the plate pressers (25) and the clamping means (24) are released, the carriage (20) returns to its rest position, and the operation of wounding the foil around the winding core starts. At the end of this operation, in a manner similar to the one described, the welding of the outlet bar onto the foil is performed.

As mentioned earlier, the welding operations carried out by the machine (1) are managed by a control unit (14), such as an on-board computer.

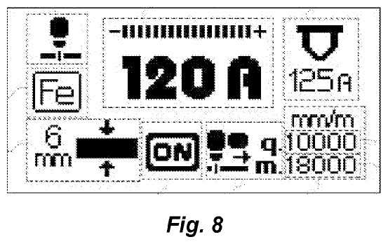

In the first preferred embodiment, described herein by way of example of the present invention and not as a limitation thereof, the control unit (14) includes a memory unit having a computer program stored thein which, in addition to managing the usual functions of the winding machine (1), is configured to manage the welding operations by means of a suitable User Interface (e.g. the UI illustrated schematically in the FIG. 8).

Furthermore in the memory unit association data can advantageously be stored. Association data relates in table form the parameters of the welding operation to be performed and the process parameters affecting the welding operation. By way of example, and not limitation of the present invention, these parameters include one or more of the following: material type of the transformer component to be welded; geometry and dimensions of the transformer component to be welded; type of conductive material to be welded; geometry and dimensions of the conductive material to be welded; type of welding i.e. head or butt welding; welding speed; power of laser radiation.

From the description provided, it shall be apparent to those skilled in the art, that the welding group (2) according to the present application can also be usefully used to retrofit or revamp winding machines not provided of any welding unit, or equipped with a non-laser welding unit, e.g. TIG type.

### SECOND PREFERRED EMBODIMENT

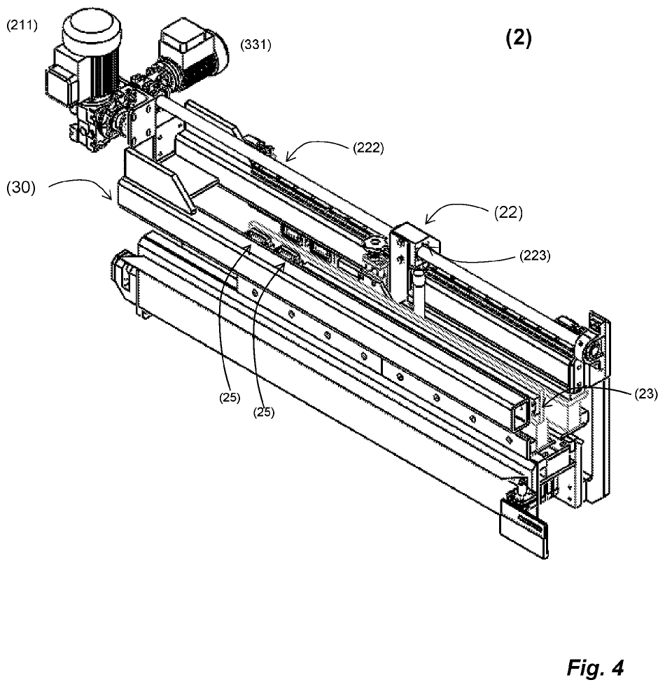

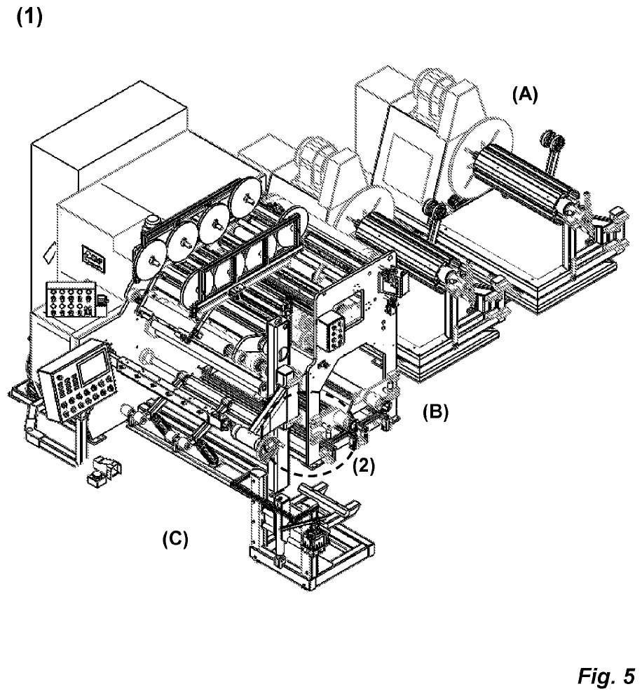

In the second preferred embodiment of the present invention, described herein by way of example, but not of limitation, with reference to the enclosed FIGS. 4 and 5, the laser welding group (2) is positioned internally, i.e. between the decoiler unit (A) and the winding unit (C). Compared to the first embodiment, in this configuration the welding group (2) is no longer mounted on a carriage, but is slidingly constrained to a translation device (30) by means of second retaining means (23), which for the sake of simplicity in this embodiment are still indicated by the same reference number as in the previous one.

In the second embodiment, the translation device (30) is a metal portion having a linear guide (222) directed along the axis (X) fixed thereto. The guide is slidingly constrained to a pair of sliding shoes (223) fixed to the laser welding head (22) by means of a supporting element. A second actuator (331) in the form of a linear motor enables movement of the laser welding head (22) constrained to the linear guide (222).

Similarly to the previous embodiment, the second retaining means (23) and the second actuator (331) may be different from those shown.

With regard to the winding machine (1), the configuration of the second preferred embodiment is particularly suitable for welding the inlet/outlet bar to the winding foil by means of the “butt” technique in which the metal foil is welded to the upper surface of the inlet/outlet bar. Depending on the geometry of the inlet/outlet bar, the welding operation by means of this technique is also performed along a straight line, parallel to the horizontal axis (X), according to a procedure which is substantially similar to the one described above. In this case, however, the plurality of pressers (25) is arranged on two lateral rows. Pressers (25), whose number is selected according to the length of the machine (1), act symmetrically with respect to the welding line to eliminate “gaps” between the foil and the inlet/outlet bars.

Other details for implementing this embodiment can be derived from the previous one, from general common knowledge known to those skilled in the art as well as by practicing the present invention.

### THIRD PREFERRED EMBODIMENT

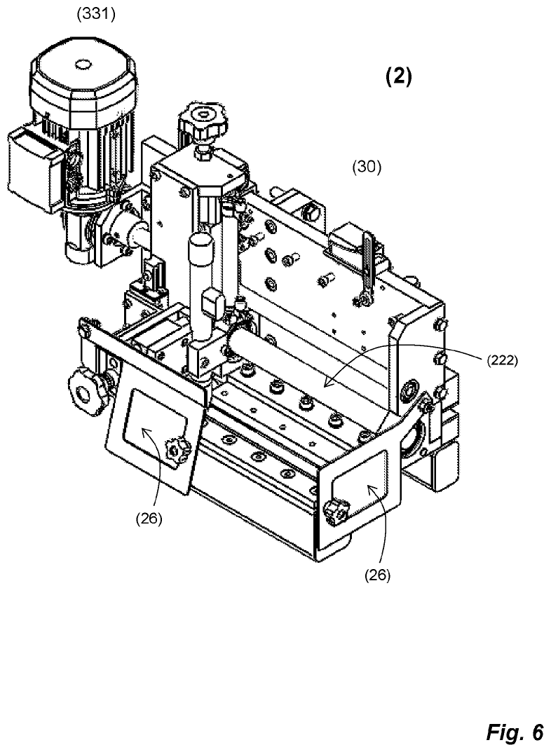

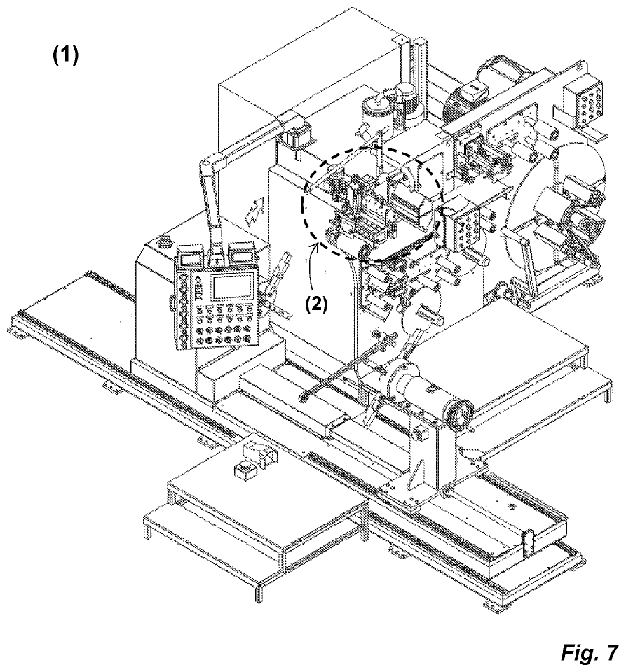

The third preferred embodiment according to the present invention, described herein by way of example, but not of limitation, with reference to the enclosed FIGS. 6 and 7, relates to a welding group (2) and a winding machine (1) suitable for manufacturing windings having the conducting material in the form of a plate or banding.

In practice, the welding group (2) has the same structure as the second preferred embodiment, although on a smaller scale. In fact, plates used in the construction of medium and high-voltage transformers typically have a length ranging from between 200 to 400 mm, and therefore the translation device (30) has a significantly reduced stroke.

From the description provided, it shall be apparent that the inventive concept underlying the invention can be applied in other embodiments than those described above. For example, the winding machine (1) according to the first embodiment, is particularly suitable for exploiting the “head welding” technique. However, by properly modifying this embodiment, it is also possible to perform “butt welding” operations. This requires the insertion of an additional row of pressers. Alternatively, the use of a hydraulic cylinder, in place of the coupling linear guide/sliding shoe driven by the electric motor, requires a manual or motorized pump and a valve to drain the fluid from the cylinder chamber to enable movement of the piston in the opposite direction.

In addition, it is possible to combine the first and second embodiments to enable the welding group (2) to perform both “head welding” and “butt welding” operations if the geometry of the transformer components requires the use of both welding techniques.

Other details for implementing this embodiment shall be obvious to those skilled in the art on the basis of the present disclosure or can be derived from general common knowledge known to those skilled in the art as well as by practicing the present invention.

### FOURTH PREFERRED EMBODIMENT

It is an object of the present invention to provide a kit suitable for retrofitting a winding machine of a conventional type, i.e., either not provided at all of a welding unit or equipped with a welding unit of a known type, for example TIG technology.

In the fourth embodiment of the present invention, described herein by way of example and not limitation, such a kit can be advantageously arranged so that a single welding unit can be shared between a plurality of winding machines. In his way, costs related with the laser welding group can be advantageously reduced and the diffusion of this technology improved.

For the sake of brevity, hereinafter the generic winding machine of said plurality will be referred to as (1j), where j is an integer index with 1≤j≤N, and N is the total number of winding machines sharing the single welding group (42).

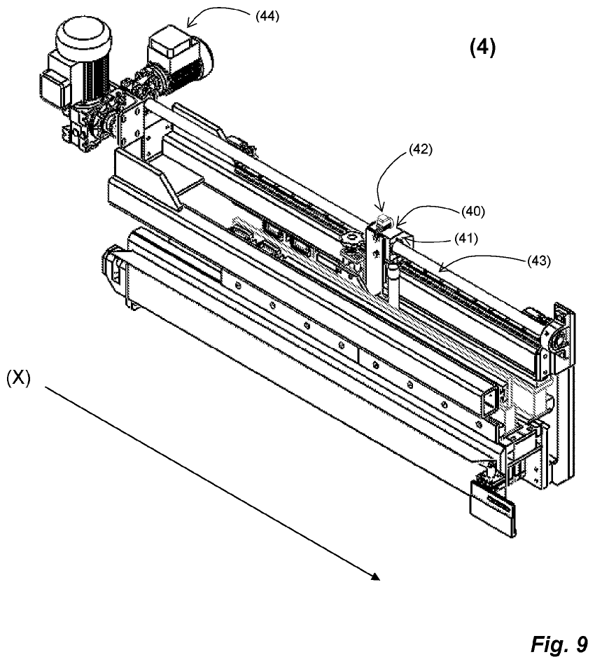

In the fourth embodiment, described herein by way of example and not limitation of the present invention, the kit is indicated by reference number (4) in the enclosed FIG. 9 and comprises: a carriage (40) slidingly constrained to a translation means (43) by means of first retaining means (41) and a laser welding head (42) integral to said carriage (40).

In such embodiment, the translation means (43) comprises a linear guide directed along the axis (X) and the first retaining means (41) are sliding shoes configured to be slidingly constrained to the linear guide (43).

The linear guide (43) is kept at a suitable height by supporting elements having bases anchored to the floor, or, alternatively, it is fixed to the structure of at least one of the winding machines (1j) sharing the single welding group (42).

However, alternative solutions for the translation means are possible, e.g. one or more tracks fixed to the floor.

Anyhow, the configuration of the translation means (43) clearly depends on the number and layout of the winding machines (40j).

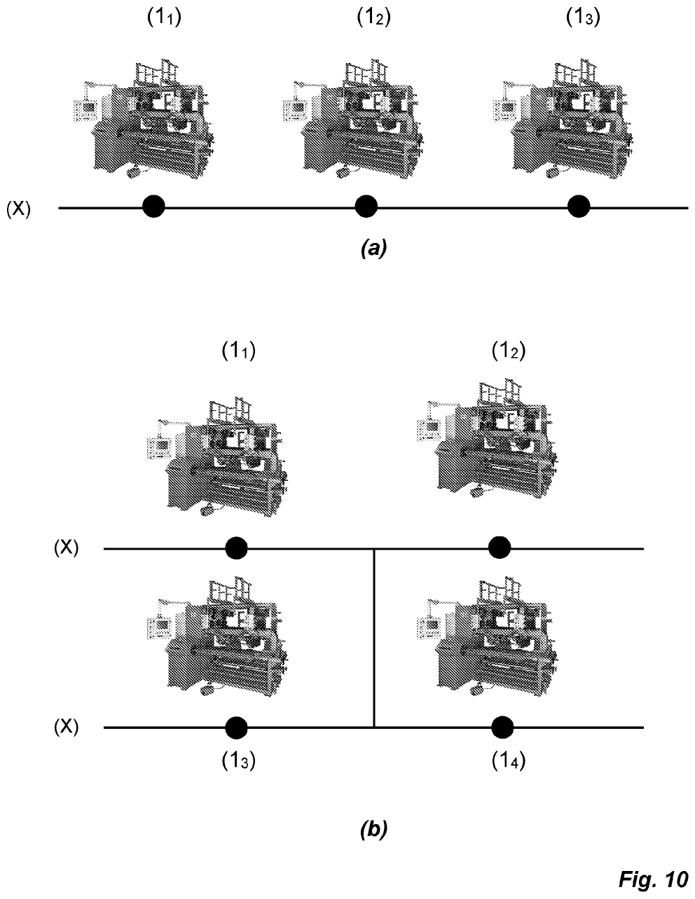

In the fourth embodiment, the laser welding unit (42) is shared by three winding machines arranged according to a “series layout”, as shown schematically in the enclosed FIG. 10(a).

In this case, the translation means (43) consists of a single linear guide (43) directed along the axis (X) suitably positioned with respect to the three winding machines (1j).

The translation means (43) is more complicated in the example illustrated schematically in the enclosed FIG. 10 (b), wherein the four machines of the plurality (1j) are arranged according to a “matrix layout” and the welding unit (42) moves along a more complex path.

In the fourth embodiment, the carriage (40), and the laser source (42) integral to it, can be moved by a linear motor (44), although other actuators useful for this purpose can also be used, e.g. a translating screw jack, a rotating screw jack, a hydraulic cylinder, a pneumatic cylinder, a ball screw, even in combination with each other.

It shall be evident to those skilled in the art that the carriage (40) can have a similar structure to that of the first embodiment, or it can have a different structure depending on, firstly the characteristics of the translation means (43), then the characteristics of the actuator (44), and finally, the layout of the winding machines plurality sharing the same laser welding group (42). For example, the actuator (44) can be even integrated into the carriage (40).

In any case, thanks to the first retaining means (41), and the first actuator (44), it is possible to move the carriage (40) along a suitable path.

In the first example, illustrated schematically in the enclosed FIG. 10(a), the 3 machines of the plurality (1j) are arranged in a “series layout” and the welding unit (42) moves along a straight path.

In the second example, schematically illustrated in the enclosed FIG. 10(b), the welding unit (42) is shared among 4 machines (1j) which are arranged according to a “matrix” layout, and hence), the welding unit (42) moves on a more complicated path than a straight path.

In the first embodiment, described herein by way of example and not as a limitation of the present invention, the kit comprising the welding group (4) includes protecting means to prevent laser dangerous exposure of operators to radiation emitted by the laser source.

Such protecting means are shielding panels fixed to the carriage (40) or to the laser welding head (42) as well as to the machines (10j) sharing the laser welding group (42).

The shielding panels can be configured and positioned along the path of the laser welding group (42) according to well-known techniques to achieve an adequate level of shielding and at the same time an effective disposal of the heat generated by the laser source.

Finally, in the fourth embodiment, a suitable control unit manages the positioning of the laser welding group (42) in correspondence with the winding machine (1j) which, according to a predefined work-cycle, is required to perform the welding operation.

Said control unit has features equivalent to those of the first embodiment described above and may coincide with the control unit on board of a “master” winding machine (1j) belonging to the plurality. Alternatively, the control unit may be a separate unit physically detached from the individual machines (1j).

Finally, it should be pointed out that for the purpose of implementing the embodiment, it is not required that the retrofit kit (4) includes the second retaining means as well as the clamping means (24) highlighted in FIG. 2. In fact, the fine movement of the laser head (22) can be obtained by suitably selecting the actuator without the use of the retaining means (23), while the clamping means (24) and the pressers (25) can be components of the machine (1j) e.g. integrated into the component feeding section.

The welding operation essentially follows the procedure of the first embodiment.

The carriage (40) with the laser welding group (42) mounted thereon, is first moved from the parking position to the working position corresponding to a machine (1j), of the plurality sharing the laser welding group (42).

The inlet bar is positioned on the bottom of the carriage (40) in a manual manner by an operator, or is picked up by an automatic loading system, which may be either specifically-dedicated to a single machine (1j) or it may be a centralized inlet bar handling systems serving all the winding machines of said plurality.

By means of the clamping means (24) of the machine (1j), the bar and the metal foil are then held together so that the edge of said foil is in contact with the head of the bar and is parallel to the head itself (i.e. it is directed along the X axis). At this stage, a suitable actuator positions the pressers (25) of the machine (1j), so that the edge of the foil are pressed against the head of the bar and the gaps between the bar and the foil are eliminated as they may slow down the welding operation or impair its quality.

Then, the laser source (22) is switched on and according to the parameters set by the operator performs the welding operation as it constrainly moves along to the linear guide (43) by means of the linear motor (411).

Taking into account the geometry of the inlet/outlet bars, the welding operation is performed along a straight path in both the “head welding” and “butt welding” techniques.

At the end of the operation, the laser source (22) is switched off, the pressers (25) and the clamping means (24) are released and the machine (1ⱼ) start to wound the foil around the winding core. At the same time, the carriage (20) moves to another winding machine (1ₖ) where k≠j is an integer index with 1≤j≤N, or it returns to its parking position on completion of the work cycle.

Welding of the outlet bar onto the foil is done by means of a sequence of operations similar to the one provided.

Other details for implementing this embodiment can be derived from the previous one, from general common knowledge known to those skilled in the art as well as by practicing the present invention.

### Advantages

From the above description, those skilled in the art shall appreciate that the improved welding group according to the present invention and the winding machine comprising said group have several advantages over known solutions.

Firstly, thanks to the intrinsic characteristics of laser radiation, it is possible to ensure a higher quality and uniformity of the weld seam and at the same time reduce the heat generated. This in turn results in increased production efficiency and safety for operators.

The use of laser technology does not require technical gases such as argon and helium, whose costs have significantly increased in recent years.

Finally, it is also possible to exploit this technology as a retrofit kit to winding machines not provided of any welding groups, as well as to machines equipped with traditional TIG welding units. In particular, such a retrofit kit can be advantageously configured to allow a single welding unit to be shared among a plurality of winding machines. In this way, cost related with the introduction of this technology can be reduced and its diffusion increased.

### Conclusions

It has been found that the invention described hereinabove fully achieves the intended aim and objects. In fact, a windings machine comprising an improved welding group has been disclosed which achieves a number of advantages in the manufacturing of windings for medium and high-voltage electrical transformers to be used in power generation, transmission and distribution applications.

It should be understood, however, that the detailed description and the specific examples, while indicating preferred embodiments of the application, are given by way of illustration only, since various changes and modifications within the spirit and scope of the application will become apparent to those skilled in the art from this detailed description.

Therefore, any modifications of the present invention that fall within the scope of the following claims are considered to be part of the present invention.

Where the characteristics and techniques mentioned in any claim are followed by reference signs, these reference marks have been applied solely for the purpose of increasing the intelligibility of the claims and consequently these reference marks have no limiting effect on the interpretation of each element identified by way of example from these reference signs.

1. Welding group (2) for a winding machine (1) for manufacturing windings for medium or high-voltage transformers, said windings comprising a conducting material in the form of wire, foil or metal plate, said welding group (2) comprising:
at least one laser welding head (22);
a handling system for said at least one laser welding head (22), said handling system comprising:
a carriage (20), in the form of a frame having a lower part (201), an upper part (201′), and at least one right side part (202) or at least one left side part (202′);
first retaining means (21) for slidingly constraining said carriage (20) to the structure of the winding machine (1), said means being placed on the upper part (201′) of the carriage (20);
a first actuator (211) which, in association with said first retaining means (21), slidingly moves said carriage (20) on at least one axis,
optionally, second retaining means (23) to slidingly retain said at least one laser welding head (22) on one or more of the parts of said carriage (20) in a way that movement along at least one axis, by means of a second actuator (231) is enabled, wherein the movement of said laser welding head (22) and the movement of said carriage (20) are independent,
or, alternatively, a handling system (20) for said at least one laser welding head (22), said handling system (20) comprising:
a translation device (30);
second retaining means (23) for slidingly constraining said at least one laser welding source (22) to said translation device (30) in a way that movement along at least one axis, by means of a third actuator (331) is enabled; and
protecting means (26), preferably panels fixed to the carriage (20), configured in a way that exposure to the radiation emitted by said at least one laser welding head (22) of operators in the working area of the winding machine (1) is prevented.

2. The welding group (2) according to claim 1 further comprising at least one of the following components:
clamping means (24), preferably in the form of one or more clamping means (24) suitable to clamp the transformer component to be welded to said conductive material, said clamping means (24) being placed on the lower part (201) of the carriage (20); or
pressing means (25), arranged on one or two rows, to simplify the welding operation of the conductive material to the transformer component, when said conductive material is in the form of metal foils or plates.

3. The welding group (2) according to claim 1 wherein said first retaining means (21) are selected from at least one of the following:
linear guides (133) directed along an x-axis (X) and fixed to the structure (10) of said winding machine (1), said linear guides (133) being slidingly constrained to sliding shoes (212) fixed to the upper side (201′) of the carriage (20) of said welding group (2); or
a rack (133) directed along the x-axis (X) and fixed to a structure (10) of said winding machine (1), said rack (133) being mechanically coupled to a first pinion (212) pivotally constrained to the upper side (201′) of the carriage (20) of said welding group (2).

4. The welding group (2) according to claim 1, wherein said second retaining means (23) are selected from at least one of the following:
at least one linear guide (222) directed along the axis (X), and fixed to said carriage (20), or to said translating element (221), said at least one linear guide (222) being slidably coupled to one or more sliding shoes (223) fixed to the laser welding head (22); or
a rack (222) directed along the axis (X), and fixed to said carriage (20), or to said translating element (221), said rack (222) being mechanically coupled to a pinion (223) pivotally constrained to the at least one laser welding head (22).

5. The welding group (2) according to claim 1, wherein said actuators (211,231,331) are selected from: a translating screw jack, a rotating screw jack, a linear motor, a hydraulic cylinder, a pneumatic cylinder, or a combination thereof.

6. Winding machine (1) for manufacturing windings for medium and high voltage electrical transformers to be used in power generation, transmission and distribution, said winding machine (1) comprising:
a decoiler unit (A) of conductive and/or insulating materials in the form of wire, foil or banding;
a winding unit (C) comprising a winding device (11′) configured to wind said conductive and/or insulating materials around a core (122) integral with a winding reel (12) which is directed horizontally along the axis (X) and is rotated by a motor (15);
optionally, a central unit (B) to prepare said conductive and/or insulating materials coming from said decoiler group (A) before entering said winding unit (C), said winding machine (1); and
a welding group (2) according to claim 1.

7. The winding machine (1) according to claim 6 further comprising means to move the winding reel (12) along a z-axis (Z) or along a y-axis (Y).

8. The winding machine (1) according to claim 6 wherein:
said welding group (2) is positioned in front of said decoiler unit (A) and is arranged to perform head welding operations in which said conductive material is welded onto a head of said transformer component; or
said welding group (2) is positioned internally, between said decoiler unit (A) and said winding unit (C) and is configured in such a way as to perform butt welding operations, wherein said conductive material is welded on an upper surface of said transformer component; or
said welding group (2) is movable between a first position in front of said decoiler unit (A) and a second position between said decoiler unit (A) and said winding unit (C), said welding group (2) being configured to perform head welding operations and butt-welding operations.

9. The winding machine (1) according to claim 6 wherein said welding group (2) is governed by a control unit (29) comprising a memory unit having a computer program executable by said control unit (29) stored therein, wherein said program is configured in a way such that a user can set the welding operation by means of an appropriate user interface, said memory unit having stored therein, preferably in tabular form, the association data between the parameters of the welding operation to be performed and the processing parameters which affect said welding operation, said processing parameters comprising at least one of the following: the type of material of the transformer component to be welded; geometry and dimensions of the transformer component to be welded; conductor material to be welded; geometry and dimensions of the conductor material to be welded; type of welding; welding speed; or intensity of laser radiation.

10. Kit (4) for retrofitting a winding machine (1) for manufacturing windings comprising the welding group (2) according to claim 1.

11. The kit (4) according to claim 10 comprising:
a carriage (40) slidingly constrained to translation means (43) by means of first retaining means (41);
a laser welding source (42) integral to said carriage (40); and
at least one actuator (44) for moving said carriage (40) by means of said translating means (43),
wherein said laser welding source (42) is shared by a number N of winding machines (40ⱼ), wherein j is an integer index with 1≤j≤N, and wherein said carriage (40) is enabled to move along a path including said winding machines (40ⱼ) by means of said means of translation (43) and said at least one actuator (44).

12. The kit according to claim 10, wherein the translation means (43) comprise one or more linear guides and the first retaining means (41) are one or more sliding shoes configured to be slidingly constrained to said one or more linear guides (43).

13. The kit according to claim 10, wherein the actuator (44) is chosen from: a translating screw jack, a rotary screw jack, a linear motor, a hydraulic cylinder, a pneumatic cylinder, a ball screw, or a combination thereof.

14. The kit according to claim 10, further comprising protection means (45) to prevent laser radiation emitted from the source (42) from causing danger to operators in a working area of the winding machine (1).
